(19) United States
(12) Patent Application Publication
(10) Pub. No.: US 2015/0213797 A1
(43) Pub. Date: Jul. 30, 2015

(54) Voice Recognition System And Method

(71) Applicant: Goertek Inc., Weifang City, ShanDong Province (CN)

(72) Inventors: Pingping Wang, Weifang City (CN); Yong Qie, Weifang City (CN)

(21) Appl. No.: 14/415,813

(22) PCT Filed: Aug. 14, 2013
(86) PCT No.: PCT/CN2013/081432

§ 371 Date: Jan. 20, 2015

(30) Foreign Application Priority Data
Aug. 15, 2012 (CN) 201210290828.6

(51) Int. Cl. G10L 17/00; H04R 3/00

(52) U.S. Cl. CPC G10L 17/00; H04R 3/00; H04R 2420/07

(57) ABSTRACT

The present invention discloses a voice recognition system and method, wherein the voice recognition system comprises: a microphone array for receiving a voice signal, converting the voice signal into an analog audio signal, and outputting the analog audio signal to an audio coding circuit; the audio coding circuit for converting the received analog audio signal into a digital audio signal, and outputting the digital audio signal to a main control integrated circuit; a Bluetooth transmitting module for receiving a voice signal, converting the voice signal into a digital audio signal, and sending the digital audio signal to a Bluetooth receiving module via Bluetooth; the Bluetooth receiving module for sending the received digital audio signal to the main control integrated circuit; the main control integrated circuit for selecting the digital audio signal from the audio coding circuit or the digital audio signal from the Bluetooth receiving module to perform recognition. The technical solution of the present invention solve the problem of the incapability of a voice recognition system, with audio input being from only a microphone array, in recognizing a long-distance voice.

### TECHNICAL FIELD

The invention relates to the field of voice recognition technology, particularly to a voice recognition system and method.

### BACKGROUND ART

Nowadays various intelligent audio-video equipments are provided with the function of voice recognition. FIG. 1 is a schematic view illustrating configuration of an audio-video equipment in prior art. As shown in FIG. 1, the audio-video equipment comprises: a microphone array 101, an audio coding circuit 102, a camera 103, a video processing circuit 104, a main control integrated circuit 105, a system main control micro controller unit (system main control MCU) 106, a loudspeaker 107 and a display screen 108.

The microphone array 101 is responsible for picking up a voice signal, convert the voice signal into an analog audio signal, and output the analog audio signal to the audio coding circuit 102; the audio coding circuit 102 digitally encodes the analog audio signal received from the microphone array 101 and then outputs it to the main control integrated circuit 105; the camera 103 is for capturing a video signal and output the video signal to a video processing circuit 104; the video processing circuit 104 is for encoding the signal outputted from the camera 103 and then outputting it to the main control integrated circuit 105. After aggregating the video signal and the audio signal, the main control integrated circuit 105 synthesizes them into an audio-video data stream and then outputs it to the system main control MCU 106. The system main control MCU 106 is a core element of the audio-video equipment, and is responsible for the management of audio-video data link. The audio signal outputted from the system main control MCU 106 is converted into a sound signal via the loudspeaker 107, and the video signal outputted from the system main control MCU 106 is displayed via the display screen 108. In addition, the audio-video equipment shown in FIG. 1 further comprises a USB interface as peripheral interface, a power circuit providing steady power for the whole system, and so on, which will not be described in detail herein.

The existing audio-video equipment which has the function of voice recognition, as shown in FIG. 1, has a certain recognition distance regardless of whether using an omnidirectional microphone array or a unidirectional microphone array, so it can only perform voice recognition within a close range and is incapable of recognizing long-distance voice.

### SUMMARY OF THE INVENTION

The present invention provides a voice recognition system and method to solve the problem of the incapability of a voice recognition system, with audio input being from only a microphone array, in recognizing a distance voice.

In order to achieve the above objective, the technical solution of the present invention is achieved as follows:

The present invention discloses a voice recognition system. comprising: a microphone array, an audio coding circuit, a main control integrated circuit. a Bluetooth receiving module, and a Bluetooth transmitting module, wherein:
the microphone array is for receiving a voice signal, converting the voice signal into an analog audio signal, and outputting the analog audio signal to the audio coding circuit;
the audio coding circuit is for converting the received analog audio signal into a digital audio signal, and outputting the digital audio signal to the main control integrated circuit;
the Bluetooth transmitting module is for receiving a voice signal, converting the voice signal into a digital audio signal, and sending the digital audio signal to the Bluetooth receiving module via Bluetooth;
the Bluetooth receiving module is for sending the received digital audio signal to the main control integrated circuit;
the main control integrated circuit is for selecting the digital audio signal from the audio coding circuit or the digital audio signal from the Bluetooth receiving module to perform voice recognition.

The aforesaid voice recognition system is provided with one Bluetooth receiving module and one or more Bluetooth transmitting module(s).

In the voice recognition system, said main control integrated circuit is provided with keys. Said main control integrated circuit selects the digital audio signal from the audio coding circuit or the digital audio signal from the Bluetooth receiving module to perform voice recognition according to user's operation to the keys.

The voice recognition system further comprises: a system main control MCU for receiving an audio data stream from the main control integrated circuit;
the system main control MCU is provided with keys. The system main control MCU sends instruction of selecting the digital audio signal from the audio coding circuit or instruction of selecting the digital audio signal from the Bluetooth receiving module to the main control integrated circuit according to user's operation to the keys;
the main control integrated circuit selects the digital audio signal from the audio coding circuit or the digital audio signal from the Bluetooth receiving module to perform voice recognition according to the instruction from the system main control MCU.

The present invention also discloses a voice recognition method, comprising the following steps:
obtaining a first digital audio signal via a microphone array receiving a voice signal, converting the voice signal into an analog audio signal, and converting the analog audio signal into a digital audio signal;
obtaining a second digital audio signal via a Bluetooth audio link receiving a voice signal and converting the voice signal into a digital audio signal; and
selecting the first digital audio signal or the second digital audio signal to perform voice recognition.

In the method, said Bluetooth audio link comprises: a Bluetooth receiving module and a Bluetooth transmitting module;
the step of receiving a voice signal and converting the voice signal into a digital audio signal via Bluetooth audio link comprises: receiving the voice signal, converting the voice signal into a digital audio signal, and sending the digital audio signal to the Bluetooth receiving module via the Bluetooth transmitting module, the Bluetooth receiving module outputting the received digital audio signal as said second digital audio signal.

The Bluetooth audio link comprises: one Bluetooth receiving module and one or more Bluetooth transmitting module(s).

In the method, the step of selecting the first digital audio signal or the second digital audio signal to perform voice recognition comprises:
selecting the first digital audio signal or the second digital audio signal according to user's operation to the keys, and performing voice recognition on the selected digital audio signal.

As can be seen, in the solution of the present invention, the voice recognition system comprises two voice input links, including the microphone array link and the Bluetooth link. Selection can be made between the two links when performing voice recognition, wherein the Bluetooth link can receive long-distance voice, thus the long-distance voice can he recognized.

### BRIEF DESCRIPTION OF THE DRAWINGS

FIG. 1 is a schematic view illustrating configuration of an audio-video equipment in prior art.

FIG. 2 is a schematic view illustrating configuration of an audio-video equipment comprising a voice recognition system in an embodiment of the present invention,

### EMBODIMENTS OF THE INVENTION

In the present invention, a first digital audio signal is obtained via a microphone array receiving a voice signal, converting the voice signal into an analog audio signal, and converting the analog audio signal into a digital audio signal; a second digital audio signal is obtained via the Bluetooth audio link receiving a voice signal and converting the voice signal into a digital audio signal: and then the first digital audio signal or the second digital audio signal is selected to perform voice recognition. In this way, some nearer voice can be picked up by the microphone array, while the voice from distant range can be received via the Bluetooth link. Therefore, the invention solves the problem of the incapability of a voice recognition system, with audio input being from only a microphone array, in recognizing a distance voice.

To make the purpose, technical solution and advantages of the invention clearer, the embodiments of the invention will be described in further detail with reference to the drawings.

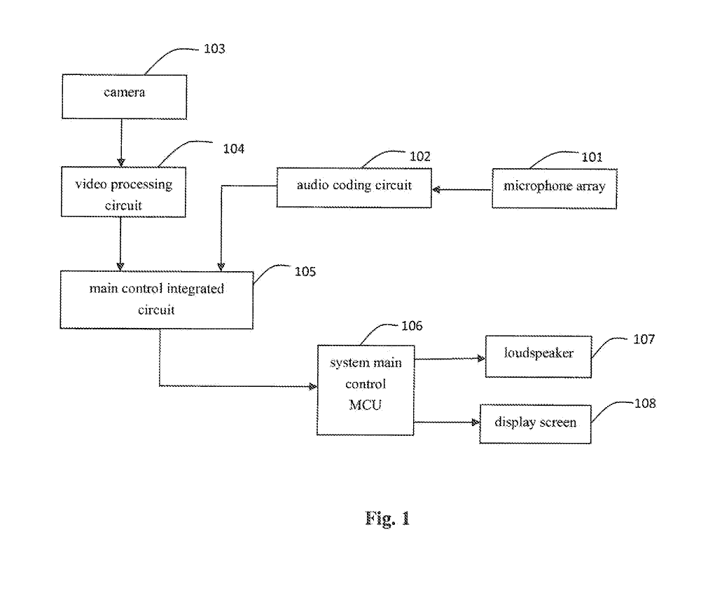

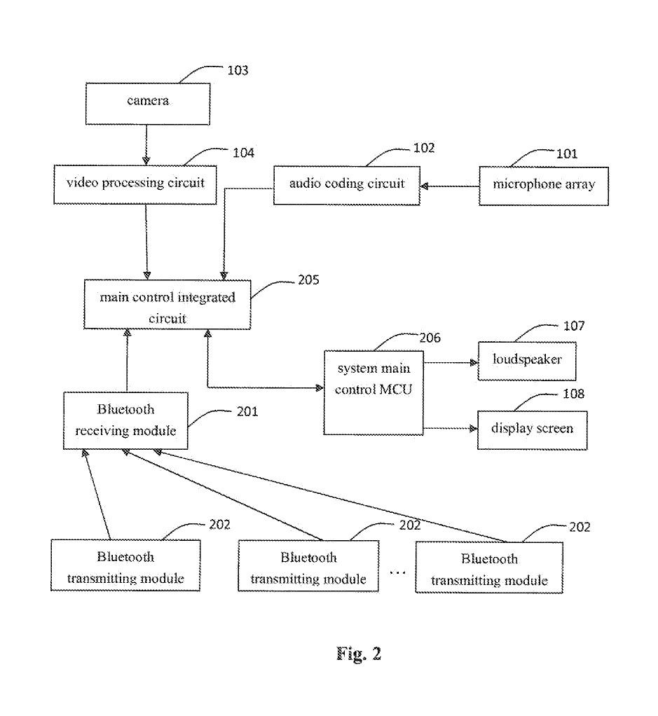

FIG. 2 is a schematic view illustrating configuration of an audio-video equipment comprising a voice recognition system in an embodiment of the present invention. As shown in FIG. 2, the system comprises: a microphone array 101, an audio coding circuit 102, a camera 103, a video processing circuit 104, a main control integrated circuit 205, a system main control MCU 206, a loudspeaker 107, a display screen 108, a Bluetooth receiving module 201 and a Bluetooth transmitting module 202. Here the number of the Bluetooth transmitting module 202 is one or more. FIG. 2 shows a plurality of Bluetooth transmitting modules 202. In addition, the functions of the main control integrated circuit and the system main control MCU have all been improved in the embodiment of the present invention, thus drawing reference signs of them in FIG. 2 are different from that in FIG. 1.

Herein, the microphone array 101 is for receiving a voice signal, converting the voice signal into an analog audio signal, and outputting the analog audio signal to the audio coding circuit 102. The audio coding circuit 102 is for converting the received analog audio signal into a digital audio signal, and outputting the digital audio signal to the main control integrated circuit 205. The camera 103 is for capturing video signal and outputting the video signal to the video processing circuit 104. The video processing circuit 104 is for encoding the signal outputted from the camera 103 and then outputting it to the main control integrated circuit 205;
the Bluetooth transmitting module 202 is for receiving a voice signal, converting the voice signal into a digital audio signal, and sending the digital audio signal to the Bluetooth receiving module 201 via Bluetooth. The Bluetooth receiving module 201 is for sending the received digital audio signal to the main control integrated circuit 205;
the main control integrated circuit 205 is for selecting the digital audio signal from the audio coding circuit 102 or the digital audio signal from the Bluetooth receiving module 201 to perform voice recognition, that is, the main control integrated circuit 205 first selects between the digital audio signal from the audio coding circuit 102 and the digital audio signal from the Bluetooth receiving module 201, then aggregates the selected digital audio signal and the digital video signal from the video processing circuit 104, synthesizes them into an audio-video data stream and outputs the data stream to the system main control MCU 206. The system main control MCU 206 is responsible for the management of audio-video data link. The audio signal outputted from the system main control MCU 206 is converted into a sound signal via the loudspeaker 107, and the video signal outputted from the system main control MCU 206 is displayed via the display screen 108.

As can be seen, in the embodiment shown in FIG. 2 there are two audio input links, which are the microphone array audio link and the Bluetooth audio link, wherein the microphone array audio link comprises: a microphone array 101 and an audio coding circuit 102. The microphone array 101 receives a voice signal, converts the voice signal into an analog audio signal, and outputs the analog audio signal to the audio coding circuit 102. The audio coding circuit 102 converts the received analog audio signal into a digital audio signal, and outputs the digital audio signal to the main control integrated circuit 205 as the first digital audio signal. The Bluetooth audio link comprises: a Bluetooth receiving module 201 and a Bluetooth transmitting module 202. The Bluetooth transmitting module 202 receives a voice signal, converts the voice signal into a digital audio signal, and sends the digital audio signal to the Bluetooth receiving module 201. The Bluetooth receiving module 201 sends the received digital audio signal to the main control integrated circuit 205 as the second digital audio signal. The main control integrated circuit 205 selects between the first digital audio signal and the second digital audio signal.

The embodiment of the present invention retains the microphone array to achieve close range voice recognition. Furthermore, a Bluetooth voice input mode is provided to achieve long-distance voice recognition. Bluetooth transmission technology supports one-to-multiple communication, namely, can arrange one Bluetooth receiving module and more than one Bluetooth transmitting modules. In practice multiple Bluetooth transmitting modules can be arranged as necessary to achieve multipoint voice recognition. Since Bluetooth mode is capable of long-distance signal transmission, the present system can perform long-distance voice recognition.

In the embodiment of the present invention, the main control integrated circuit 205 can be controlled to select the digital audio signal via the keys.

For example, a keypad-type control terminal can be installed on the main control integrated circuit 205, and the main control integrated circuit 205 selects the digital audio signal from the audio coding circuit 102 or the digital audio signal from the Bluetooth receiving module 201 to perform voice recognition according to user's operation to the keys.

Or, a keypad-type control terminal can be installed on the system main control MCU 206, and the system main control MCU 206 sends instruction of selecting the digital audio signal from the audio coding circuit 102 or instruction of selecting the digital audio signal from the Bluetooth receiving module 201 to the main control integrated circuit 205 according to user's operation to the keys; the main control integrated circuit 205 selects the digital audio signal from the audio coding circuit 102 or the digital audio signal from the Bluetooth receiving module 201 to perform voice recognition according to the instructions from the system main control MCU 206, which constitutes the improvement of the system main control MCU in the embodiment of the present invention.

In summary, in the solution of the present invention, the voice recognition system comprises two voice input links, including the microphone array link and the Bluetooth link. Selection is made between the two links when performing voice recognition, wherein the Bluetooth link can receive long-distance voice and achieve multipoint voice control, thus the system can recognize multiple long-distance voices and users can better experience the superiority of voice recognition. The foregoing descriptions merely illustrate preferred embodiments of the present invention, and are not intended to limit the protection scope of the present invention. Any modification, equivalent replacement and improvement made within the spirit and principle of the present invention shall fall into the protection scope of the present invention.

1. A voice recognition system, characterized in comprising: a microphone array, an audio coding circuit, a main control integrated circuit, a Bluetooth receiving module, and a Bluetooth transmitting module, wherein:
the microphone array is for receiving a voice signal, converting the voice signal into an analog audio signal, and outputting the analog audio signal to the audio coding circuit;
the audio coding circuit is for converting the received analog audio signal into a digital audio signal, and outputting the digital audio signal to the main control integrated circuit;
the Bluetooth transmitting module is for receiving a voice signal, converting the voice signal into a digital audio signal, and sending the digital audio signal to the Bluetooth receiving module via Bluetooth;
the Bluetooth receiving module is for sending the received digital audio signal to the main control integrated circuit; and
the main control integrated circuit is for selecting the digital audio signal from the audio coding circuit or the digital audio signal from the Bluetooth receiving module to perform voice recognition.

2. The voice recognition system according to claim 1, characterized in that: said voice recognition system is provided with one Bluetooth receiving module and one or more Bluetooth transmitting module(s).

3. The voice recognition system according to claim 1, characterized in that: said main control integrated circuit is provided with keys; said main control integrated circuit selects the digital audio signal from the audio coding circuit or the digital audio signal from the Bluetooth receiving module to perform voice recognition according to user's operation to the keys.

4. The voice recognition system according to claim 1, characterized in that: said voice recognition system further comprises: a system main control MCU for receiving an audio data stream from the main control integrated circuit;
the system main control MCU is provided with keys; the system main control MCU sends instruction of selecting the digital audio signal from the audio coding circuit or instruction of selecting the digital audio signal from the Bluetooth receiving module to the main control integrated circuit according to user's operation to the keys;
the main control integrated circuit selects the digital audio signal from the audio coding circuit or the digital audio signal from the Bluetooth receiving module to perform voice recognition according to the instruction from the system main control MCU.

5. A voice recognition method, characterized in that the method comprises the following steps:
obtaining a first digital audio signal via a microphone array receiving a voice signal, converting the voice signal into an analog audio signal, and converting the analog audio signal into a digital audio signal;
obtaining a second digital audio signal via a Bluetooth audio link receiving a voice signal and converting the voice signal into a digital audio signal; and
selecting the first digital audio signal or the second digital audio signal to perform voice recognition.

6. The voice recognition method according to claim 5, characterized in that: said Bluetooth audio link comprises: a Bluetooth receiving module and a Bluetooth transmitting module;
the step of receiving a voice signal and converting the voice signal into a digital audio signal via a Bluetooth audio link comprises: receiving the voice signal, converting the voice signal into a digital audio signal, and sending the digital audio signal to the Bluetooth receiving module via the Bluetooth transmitting module; the Bluetooth receiving module outputting the received digital audio signal as said second digital audio signal.

7. The voice recognition method according to claim 6, characterized in that: said Bluetooth audio link comprises: one Bluetooth receiving module and one or more Bluetooth transmitting module(s).

8. The voice recognition method according to claim 5, characterized in that: the step of selecting the first digital audio signal or the second digital audio signal to perform voice recognition comprises:
selecting the first digital audio signal or the second digital audio signal according to user's operation to the keys, and performing voice recognition on the selected digital audio signal.
